(19) United States
(12) Patent Application Publication
(10) Pub. No.: US 2024/0332604 A1
(43) Pub. Date: Oct. 3, 2024

(54) SOLID ELECTROLYTE COMPOSITE

(71) Applicant: HONDA MOTOR CO., LTD., Tokyo (JP)

(72) Inventors: Kizashi IWAKIRI, Saitama (JP); Takuya TANIUCHI, Saitama (JP); Toshimitsu TANAKA, Saitama (JP)

(21) Appl. No.: 18/585,078

(22) Filed: Feb. 23, 2024

(30) Foreign Application Priority Data
Mar. 31, 2023 (JP) 2023-058556

(51) Int. Cl. H01M 10/0562; H01M 10/0525

(52) U.S. Cl. CPC H01M 10/0562; H01M 10/0525; H01M 2300/0068; H01M 2300/0094

(57) ABSTRACT

The present disclosure relates to a solid electrolyte composition that can achieve compatibility between energy density and strength of a solid-state battery. Provided is a solid electrolyte composite disposed between a positive electrode layer and a negative electrode layer in a solid-state battery, comprising a positive electrode side solid electrolyte layer disposed in a side closer to the positive electrode layer and a negative electrode side solid electrolyte layer disposed in a side closer to the negative electrode layer, the solid electrolyte composite having a stepped shape having a step between the positive electrode side solid electrolyte layer and the negative electrode side solid electrolyte layer, at least the negative electrode side solid electrolyte layer comprising a filler and/or a porous substrate, the negative electrode side solid electrolyte layer having a higher content of the filler and/or the porous substrate than the positive electrode side solid electrolyte layer.

This application is based on and claims the benefit of priority from Japanese Patent Application No. 2023-058556, filed on 31 Mar. 2023, the content of which is incorporated herein by reference.

### BACKGROUND OF THE INVENTION

### Field of the Invention

The present invention relates to a solid electrolyte composite.

### Related Art

In recent years, research and development have been conducted on secondary batteries that contribute to energy efficiency, in order to ensure more people have access to reliable, sustainable, and advanced energy at an affordable price.

As the secondary battery, a solid-state battery including a solid electrolyte is known. As a technique relating to the solid-state battery, a solid electrolyte laminate comprising a multi-layer structure comprising a first low content insulator-containing solid electrolyte layer, a high content insulator-containing solid electrolyte layer, and a second low content insulator-containing solid electrolyte layer laminated in this order is disclosed. In the solid electrolyte laminate, a content of the insulator in each of the first and the second low content insulator-containing solid electrolyte layers is lower than the content of the high content insulator-containing solid electrolyte layer (for example, see Patent Document 1).
Patent Document 1: Japanese Unexamined Patent Application, Publication No. 2019-185877

### SUMMARY OF THE INVENTION

An object of the technique disclosed in Patent Document 1 is to suppress internal short circuit and a decrease in discharge capacity by blending an insulator such as alumina into the solid electrolyte. On the other hand, in consideration of energy density, the solid electrolyte needs to be thin and have strength to withstand a high restraining pressure. However, under the present circumstance, there is no detailed investigation on the configuration of the solid-state battery in which compatibility between energy density and strength is achieved.

The present invention has been made in consideration of the above circumstance, and it is an object of the present invention to provide a solid electrolyte composite capable of achieving compatibility between energy density and strength of a solid-state battery.

A first aspect of the present invention relates to a solid electrolyte composite disposed between a positive electrode layer and a negative electrode layer in a solid-state battery, the solid electrolyte composite including a positive electrode side solid electrolyte layer disposed in a side closer to the positive electrode layer and a negative electrode side solid electrolyte layer disposed in a side closer to the negative electrode layer; the solid electrolyte composite having a stepped shape having a step between the positive electrode side solid electrolyte layer and the negative electrode side solid electrolyte layer; at least the negative electrode side solid electrolyte layer including a filler and/or a porous substrate; the negative electrode side solid electrolyte layer having a higher content of the filler and/or the porous substrate than the positive electrode side solid electrolyte layer.

According to the invention as described in the first aspect, it is possible to provide a solid electrolyte composite capable of achieving the compatibility between energy density and strength of the solid-state battery.

A second aspect relates to the solid electrolyte composite as described in the first aspect, in which the negative electrode side solid electrolyte layer has a lower content of the filler and/or the porous substrate in the vicinity of an interface in a side closer to the negative electrode layer and the vicinity of an interface in a side closer to the positive electrode side solid electrolyte layer than in another portion, and the positive electrode side solid electrolyte layer has a lower content of the filler and/or the porous substrate in the vicinity of an interface in a side closer to the positive electrode layer and the vicinity of an interface in a side closer to the negative electrode side solid electrolyte layer than in another portion.

According to the invention as described in the second aspect, a reaction area is ensured on an interface between the positive electrode side solid electrolyte layer and another layer as well as on an interface between the negative electrode side solid electrolyte layer and another layer, and thereby a decrease in ion conductivity is suppressed. Further, bonding properties of the positive electrode side solid electrolyte layer to the other layer as well as the negative electrode side solid electrolyte layer to the other layer can be improved. Further, by reducing the total amount of the filler and/or the porous substrate and suppressing a decrease in ion conductivity, output of the solid-state battery can be improved and required strength can be maintained.

A third aspect relates to the solid electrolyte composite as described in the first or second aspect, in which the solid-state battery further includes an insulating member, and each of the positive electrode side solid electrolyte layer and the negative electrode side solid electrolyte layer has a lower content of the filler and/or the porous substrate in the vicinity of an interface with the insulating member than in another portion.

According to the invention as described in the third aspect, the compatibility between energy density and strength of the solid-state battery can be more preferably achieved.

A fourth aspect relates to the solid electrolyte composite as described in any one of the first to third aspects, in which a high content of filling material-containing region that includes the filler and/or the porous substrate in a higher content than another portion is provided inside the solid electrolyte composite, and the high content of filling material-containing region has a stepped shape having a step between the side closer to the positive electrode side solid electrolyte layer and the side closer to the negative electrode side solid electrolyte layer.

According to the invention as described in the fourth aspect, when θ misalignment during lamination is suppressed by the stepped shape of the solid electrolyte composite, the solid electrolyte composite can have strength sufficient to withstand impact during the lamination, enabling maintenance of the shape of the solid electrolyte composite.

### BRIEF DESCRIPTION OF THE DRAWINGS

FIG. 1 is a top view showing a solid-state battery according to a first embodiment;

FIG. 2 is a cross-sectional view taken along line A-A of FIG. 1;

FIG. 3 is a cross-sectional view taken along line B-B of FIG. 1;

FIG. 4 is a cross-sectional view schematically showing the solid electrolyte composite shown in FIG. 3;

FIG. 5 is a cross-sectional view corresponding to FIG. 3 of the solid electrolyte composite according to a second embodiment;

FIG. 6 is a cross-sectional view corresponding to FIG. 3 of a solid electrolyte composite according to a third embodiment; and

FIG. 7 is a cross-sectional view corresponding to FIG. 3 of a solid electrolyte composite according to a fourth embodiment.

### DETAILED DESCRIPTION OF THE INVENTION

### <Solid-State Battery>

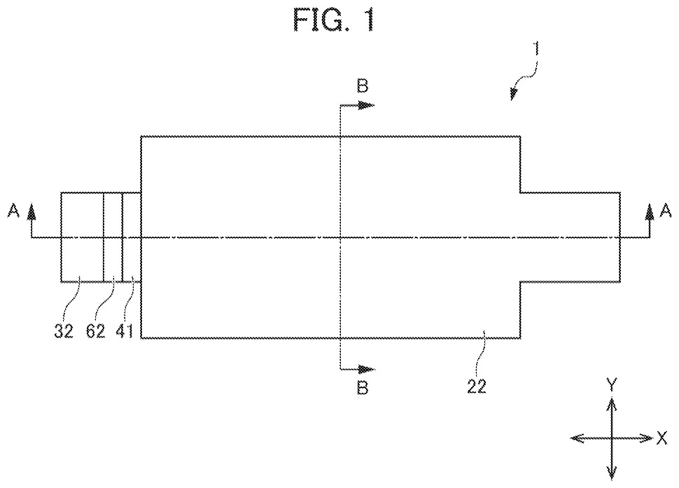

As shown in FIGS. 1 to 3, a solid electrolyte composite 40 according to the present embodiment is laminated and disposed between a negative electrode layer composed of a negative electrode material mixture layer 21 and a negative electrode current collector 22, and a positive electrode layer composed of a positive electrode material mixture layer 31 and a positive electrode current collector 32 in a solid-state battery 1. In the present embodiment, the solid-state battery 1 includes, in addition to the above, an intermediate layer 50 and an insulating frame 61 and an insulating layer 62 as the insulating member.

The solid-state battery 1 is not particularly limited as long as it is a solid-state battery having a solid electrolyte, but is preferably, for example, an all-solid lithium metal using a lithium metal or a lithium alloy as the negative electrode, or an all-solid lithium ion battery using silicon or tin as the negative electrode. This is because the solid-state battery relatively considerably expands and contracts due to charge and discharge and thus is restrained by a high restraining pressure; thus, the solid electrolyte layer (laminate) is required to have high strength.

### <Solid Electrolyte Composite>

### First Embodiment

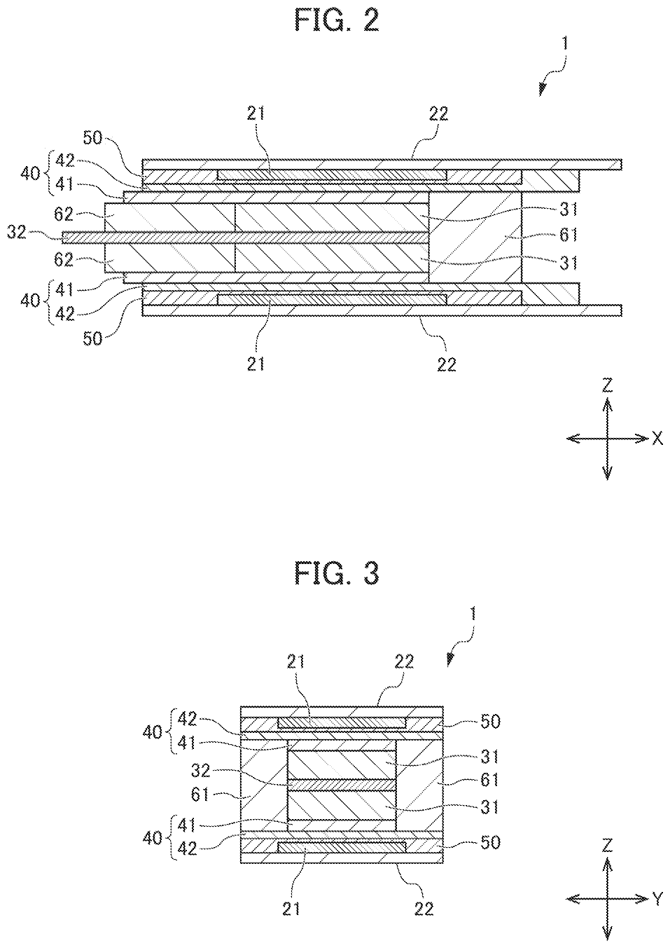

As shown in FIGS. 2 and 3, the solid electrolyte composite 40 according to the present embodiment is formed by laminating a positive electrode side solid electrolyte layer 41 disposed in the side closer to the positive electrode layer and a negative electrode side solid electrolyte layer 42 disposed in the side closer to that negative electrode layer.

The positive electrode side solid electrolyte layer 41 and the negative electrode side solid electrolyte layer 42 include a solid electrolyte as an essential component. The solid electrolyte is not particularly limited as long as it is a material capable of conducting lithium ions, and examples thereof include an oxide-based electrolyte and a sulfide-based electrolyte.

As shown in FIGS. 2 to 4, the positive electrode side solid electrolyte layer 41 and the negative electrode side solid electrolyte layer 42 each have a stepped shape having a step between the positive electrode side solid electrolyte layer 41 and the negative electrode side solid electrolyte layer 42. With the above configuration, θ misalignment during the lamination can be suppressed. In the present embodiment, in a direction (direction Y in each drawing) orthogonal to a current collector extending direction (direction X in each drawing) and a lamination direction (direction Z in each drawing), length L1 in direction Y of the positive electrode side solid electrolyte layer 41 is shorter than length L2 in direction Y of the negative electrode side solid electrolyte layer 42. A ratio of length L1 and L2 is not particularly limited, but may be, for example, L1:L2=1:1.001 to 1:2.

The negative electrode side solid electrolyte layer 42 includes a filler and/or a porous substrate. As shown in FIG. 2, the negative electrode side solid electrolyte layer 42 is disposed so as to abut on the insulating frame 61 in lamination direction Z and partially cover the intermediate layer 50. The end portion of the negative electrode side solid electrolyte layer 42 in the current collector extending direction (direction X in FIG. 2) extends outward from the center of the solid-state battery 1 beyond the insulating frame 61. In order to allow a certain degree of reaction non-uniformity when the negative electrode layer expands and contracts and to maintain the electrode structure, the negative electrode side solid electrolyte layer 42 having the above configuration is required to have high strength to keep the electrode structure. Further, in the manufacturing process of the solid-state battery 1, the negative electrode side solid electrolyte layer 42 and the negative electrode layer as well as the positive electrode side solid electrolyte layer 41 and the positive electrode layer may be separately formed and bonded together in some cases. In such cases, the negative electrode side solid electrolyte layer 42 and the negative electrode layer are thinner in the lamination direction (direction Z in FIG. 2) than the positive electrode side solid electrolyte layer 41 and the positive electrode layer. Therefore, in order to improve handling properties of the negative electrode side solid electrolyte layer 42 and the negative electrode layer, the negative electrode side solid electrolyte layer 42 is required to have high strength.

Inclusion of the filler and/or the porous substrate in the negative electrode side solid electrolyte layer 42 imparts toughness and improves strength against external pressure. Further, for example, the energy density of the solid-state battery 1 can be more satisfactorily improved as compared to a case where a SUS plate or a nonwoven fabric having a size equal to or larger than a predetermined size is used for the negative electrode side solid electrolyte layer 42. The filler is not particularly limited, and examples thereof include organic fillers such as polyethylene terephthalate (PET), polyamide, polyimide, and polycarbonate, and inorganic fillers. The filler may be fibrous, particulate or bulky. The porous substrate is a substrate having voids formed therein, and the voids in the porous substrate are impregnated with a solid electrolyte. Examples of the porous substrate include a nonwoven fabric, a woven fabric, an organic porous body, and an inorganic porous body. Examples of the shapes of the organic porous body and the inorganic porous body include a mesh body, an embossed body, a punched body, an expanded body, and a foamed body. The porous substrate may have a predetermined shape or may be cut fine. Both the filler and the porous substrate have electron insulating properties.

A content of the filler and/or the porous substrate in the negative electrode side solid electrolyte layer 42 is not particularly limited, but may be, for example, greater than 0% by mass and 50% by mass or less.

The positive electrode side solid electrolyte layer 41 may also include the filler and/or the porous substrate. Considering the energy density of the solid-state battery 1, it is necessary to reduce the thickness of the solid electrolyte composite 40 in lamination direction Z. This is because the positive electrode side solid electrolyte layer 41 is also required to have a certain degree of strength corresponding to the thickness. However, the content of the filler and/or the porous substrate is higher in the negative electrode side solid electrolyte layer 42, which is required to have higher strength, than in the positive electrode side solid electrolyte layer 41. Hereinafter, a configuration in which a predetermined amount of the filler and/or the porous substrate is included in the positive electrode side solid electrolyte layer 41 will be described, but the positive electrode side solid electrolyte layer 41 may not include the filler and/or the porous substrate.

The positive electrode side solid electrolyte layer 41 and the negative electrode side solid electrolyte layer 42 preferably have a lower content of the filler and/or the porous substrate in the vicinity of the interfaces with the other layers than in other portions. Thereby, a reaction area is ensured on an interface between the positive electrode side solid electrolyte layer 41 and the other layer as well as on an interface between the negative electrode side solid electrolyte layer 42 and the other layer, and thereby a decrease in ion conductivity is suppressed. Further, the bonding properties of each of the positive electrode side solid electrolyte layer 41 to the other layer as well as the negative electrode side solid electrolyte layer 42 to the other layer can be improved. Further, the total amount of the filler and/or the porous substrate can be reduced, the energy density of the solid-state battery 1 can be improved, and the required strength can be maintained.

The interface between the positive electrode side solid electrolyte layer 41 and the other layer means an interface between the positive electrode side solid electrolyte layer 41 and the positive electrode material mixture layer 31, and an interface between the positive electrode side solid electrolyte layer 41 and the negative electrode side solid electrolyte layer 42.

The interface between the negative electrode side solid electrolyte layer 42 and the other layer means an interface between the negative electrode side solid electrolyte layer 42 and the intermediate layer 50, and an interface between the negative electrode side solid electrolyte layer 42 and the positive electrode side solid electrolyte layer 41.

In addition to the above, the positive electrode side solid electrolyte layer 41 and the negative electrode side solid electrolyte layer 42 preferably have a lower content of the filler and/or the porous substrate on the interface with the insulating frame 61 and/or the insulating layer 62 as the insulating member than in another portion.

A solid electrolyte for bonding may be applied to the interface between the positive electrode side solid electrolyte layer 41 and the negative electrode side solid electrolyte layer 42. Thereby, the bonding properties between the positive electrode side solid electrolyte layer 41 and the negative electrode side solid electrolyte layer 42 can be improved.

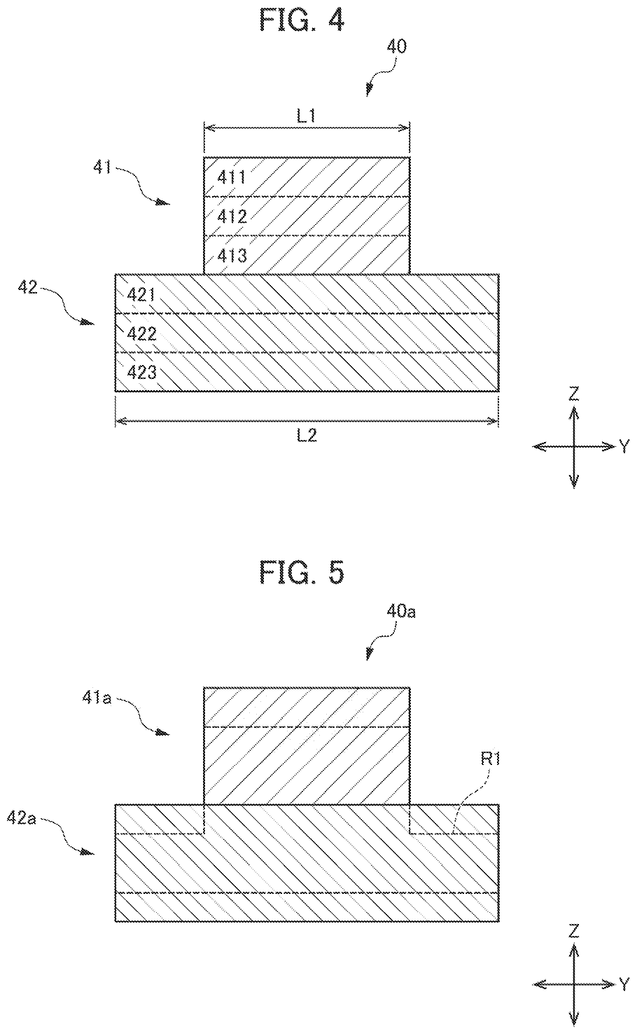

Specific embodiments of the positive electrode side solid electrolyte layer 41 and the negative electrode side solid electrolyte layer 42 having the above-described contents of the filler and/or the porous substrate include those shown in FIG. 4. In FIG. 4, the positive electrode side solid electrolyte layer 41 is composed of solid electrolyte layers 411, 412, and 413. The solid electrolyte layers 411 and 413 have lower contents of the filler and/or the porous substrate than the solid electrolyte layer 412. Similarly, the negative electrode side solid electrolyte layer 42 is composed of solid electrolyte layers 421, 422, and 423. The solid electrolyte layers 421 and 423 have lower contents of the filler and/or the porous substrate than the solid electrolyte layer 422. Each of the layers can be formed by laminating layers having different contents of the filler and/or the porous substrate.

When the positive electrode side solid electrolyte layer 41 and the negative electrode side solid electrolyte layer 42 have a plurality of layers each having a different content of the filler and/or porous substrate content, the filler and/or porous substrate content of the positive electrode side solid electrolyte layer 41 and that of the negative electrode side solid electrolyte layer 42 mean an average content of the filler and/or the porous substrate of each layer.

### (Negative Electrode Layer)

The negative electrode material mixture layer 21 includes a negative electrode active material as an essential component, and may further include a solid electrolyte, a conductive aid, a binder, and the like. The negative electrode active material is not particularly limited as long as it can absorb and release lithium ions, and examples thereof include metallic lithium, a lithium alloy, a metal oxide, a metal sulfide, a metal nitride, Si, SiO, a carbon material, and the like. Examples of the carbon material include artificial graphite, natural graphite, hard carbon, and soft carbon.

The negative electrode current collector 22 is not particularly limited, and examples thereof include metal foils such as copper (Cu) foil and stainless steel (SUS) foil.

### (Positive Electrode Layer)

The positive electrode material mixture layer 31 includes a positive electrode active material as an essential component, and may further include a solid electrolyte, a conductive aid, a binder, and the like. The positive electrode active material is not particularly limited, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide and sulfur. In the present embodiment, the positive electrode material mixture layer 31 is laminated on both surfaces of the positive electrode current collector 32.

The positive electrode current collector 32 is not particularly limited, and examples thereof include aluminum (Al) foil and stainless steel (SUS) foil.

### (Intermediate Layer)

The intermediate layer 50 has a function of enabling uniform deposition of Li metal, for example, when the solid-state battery 1 is a lithium metal secondary battery. Therefore, the interface between the intermediate layer 50 and the negative electrode side solid electrolyte layer 42 is stabilized. The material of the intermediate layer 50 is not particularly limited, and examples thereof include carbon on which a metal (for example, Ag or the like) capable of alloying with Li is supported. Here, the lithium metal secondary battery may be an anode free battery in which the negative electrode material mixture layer 21 does not exist during the first charge. In this case, after the first charge and discharge, a lithium metal layer is formed as the negative electrode material mixture layer 21.

As shown in FIGS. 2 and 3, when viewed from lamination direction Z, the intermediate layer 50 has an outer peripheral edge located outside the outer peripheral edge of the negative electrode material mixture layer 21, and a part of the intermediate layer 50 is in contact with a part of the outer peripheral side of the negative electrode current collector 22. Hence, occurrence of a short circuit is suppressed.

### (Insulating Member)

The insulating frame 61 improves the strength of the solid-state battery 1. As shown in FIGS. 2 and 3, the insulating frame 61 is provided on an outer peripheral portion in a direction orthogonal to lamination direction Z of the positive electrode material mixture layer 31 and the positive electrode current collector 32. The material constituting the insulating frame 61 is not particularly limited as long as it has electron insulating properties, and examples thereof include insulating oxides such as alumina, resins such as polyvinylidene fluoride (PVDF), and rubbers such as styrene-butadiene rubber (SBR). The insulating frame 61 may have ion conductivity.

The insulating layer 62 is formed in a region where a positive electrode tab extends from the positive electrode current collector 32. The insulating layer 62 suppresses occurrence of short circuit. The insulating layer 62 may be made of the same material as the insulating frame 61.

In the solid-state battery 1, the intermediate layer 50 and/or the insulating member may not be formed as necessary.

### [Manufacturing Method of Solid-State Battery]

The method of manufacturing the solid-state battery 1 is not particularly limited, but examples thereof include the following method. First, the positive electrode material mixture layer 31 and the insulating layer 62 are formed in predetermined regions on both surfaces of a substrate for the positive electrode current collector by a coating method. Next, the positive electrode side solid electrolyte layer 41 is formed by a transfer method or a coating method in a predetermined region of the positive electrode current collector substrate on which the positive electrode material mixture layer 31 and the insulating layer 62 have been formed. Next, after roll pressing, the resulting laminate is punched into a predetermined shape to obtain a positive electrode-solid electrolyte laminate. Therefore, the shape and size of the end portion of the positive electrode-solid electrolyte laminate can be controlled, and misalignment of the positive electrode material mixture layer 31 on the front and back surfaces of the positive electrode current collector 32 can be suppressed. Further, adhesion between the positive electrode material mixture layer 31 and the positive electrode side solid electrolyte layer 41 is improved, and protrusion of the positive electrode side solid electrolyte layer 41 can be suppressed.

The negative electrode material mixture layer 21 is formed in a predetermined region of one surface of a negative electrode current collector substrate by a coating method. Next, the intermediate layer 50 is formed by a transfer method or a coating method, in a predetermined region of the negative electrode current collector substrate having the negative electrode material mixture layer 21 formed thereon. Next, the negative electrode side solid electrolyte layer 42 is formed by a transfer method or a coating method, in a predetermined region of the negative electrode current collector substrate on which the intermediate layer 50 has been formed. Next, after roll pressing, the resulting laminate is punched into a predetermined shape to obtain a negative electrode-intermediate layer-solid electrolyte laminate. Thereby, contact between the negative electrode material mixture layer 21 and the negative electrode side solid electrolyte layer 42 is suppressed, and the detachment of the intermediate layer 50 is suppressed. Further, adhesion of the negative electrode material mixture layer 21, the intermediate layer 50, and the negative electrode side solid electrolyte layer 42 is improved, and protrusion of the intermediate layer 50 and the negative electrode side solid electrolyte layer 42 is suppressed.

The insulating frame 61 is disposed at a predetermined position of the negative electrode-intermediate layer-solid electrolyte laminate. Next, the positive electrode-solid electrolyte laminate is disposed at a predetermined position of the negative electrode-intermediate layer-solid electrolyte laminate in which the insulating frame 61 has been disposed so that the positive electrode side solid electrolyte layer 41 and the negative electrode side solid electrolyte layer 42 face each other. Next, another negative electrode-intermediate layer-solid electrolyte laminate is disposed at a predetermined position of the negative electrode-intermediate layer-solid electrolyte laminate in which the insulating frame 61 and the positive electrode-solid electrolyte laminate have been disposed so that the positive electrode side solid electrolyte layer 41 and the negative electrode side solid electrolyte layer 42 face each other, followed by uniaxial press to obtain the solid-state battery 1.

Here, when disposing the positive electrode-solid electrolyte laminate and the negative electrode-intermediate layer-solid electrolyte laminate, a solvent capable of dissolving the solid electrolyte constituting the solid electrolyte composite 40 or a slurry containing the solid electrolyte is applied to the interface between the positive electrode side solid electrolyte layer 41 and the negative electrode side solid electrolyte layer 42. Thereby, the positive electrode side solid electrolyte layer 41 and the negative electrode side solid electrolyte layer 42 are bonded to each other, resulting in a decrease in the interface resistance. In order to remove the solvent used for bonding the positive electrode side solid electrolyte layer 41 and the negative electrode side solid electrolyte layer 42 or the solvent contained in the slurry, heating and drying may be performed as necessary. Timing of heating and drying may be before or after the uniaxial press. For example, the solid-state battery 1 may be restrained by an endplate and then heated and dried. Thereby, lamination misalignment and occurrence of partial contact of the solid-state battery 1 are suppressed.

The method of manufacturing the solid-state battery 1 is not limited to the above, and for example, the solid electrolyte composite 40 may be separately formed and then bonded to other layers or members.

Next, a configuration of a solid electrolyte composite according to another embodiment of the present invention will be described. The same components as those of the solid electrolyte composite 40 described above are denoted by the same reference numerals, and description thereof may be omitted.

### Second Embodiment

As shown in FIG. 5, a solid electrolyte composite 40a according to the present embodiment includes a positive electrode side solid electrolyte layer 41a and a negative electrode side solid electrolyte layer 42a. The solid electrolyte composite 40a is provided with a high content of filling material-containing region R1 in which the content of the filler and/or the porous substrate is higher than in other portions. The high content of filling material-containing region R1 has a stepped shape obtained by downscaling the solid electrolyte composite 40a. That is, the length in direction Y of the high content of filling material-containing region R1 in the side closer to the positive electrode side solid electrolyte layer 41a is shorter than the length in direction Y in the side closer to the negative electrode side solid electrolyte layer 42a. Thereby, when θ misalignment during the lamination is suppressed by the solid electrolyte composite 40a, the solid electrolyte composite 40a can have strength sufficient to withstand the impact during the lamination, enabling maintenance of the shape of the solid electrolyte composite 40a.

A method of manufacturing the solid electrolyte composite 40a is not particularly limited, but may be a method in which the high content of filling material-containing region R1 is first formed using a mold corresponding to the shape of the high content of filling material-containing region R1, using a solid electrolyte slurry into which a relatively large amount of the filler and/or the porous substrate is blended, and then a portion other than the high content of filling material-containing region R1 is coated with a solid electrolyte slurry into which a relatively small amount of the filler and/or the porous substrate is blended.

### Third Embodiment

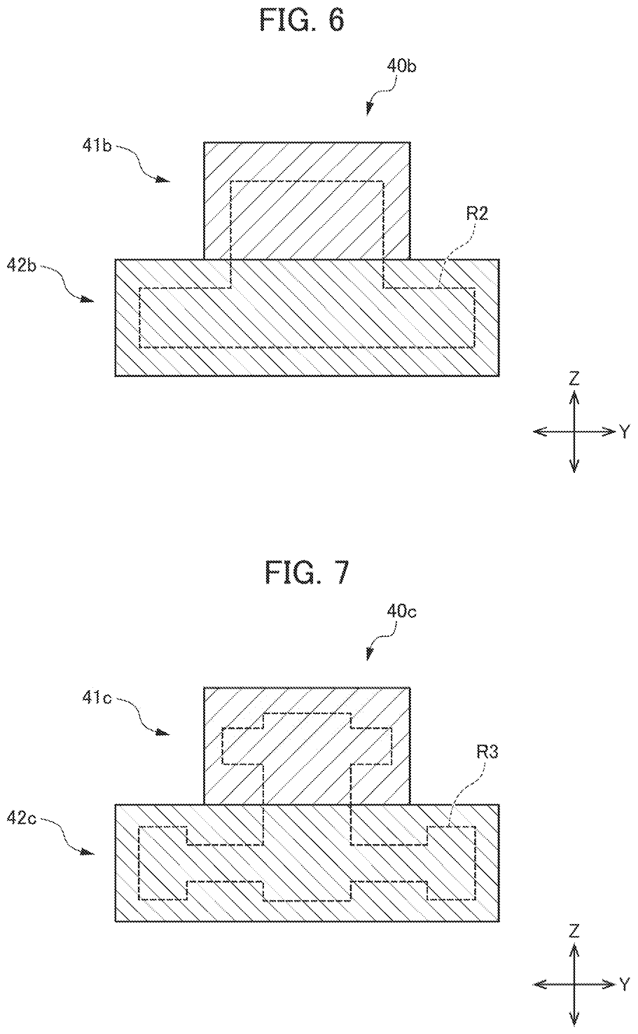

As shown in FIG. 6, a solid electrolyte composite 40b according to the present embodiment includes a positive electrode side solid electrolyte layer 41b and a negative electrode side solid electrolyte layer 42b. The solid electrolyte composite 40b has a high content of filling material-containing region R2 having a stepped shape similar to the solid electrolyte composite 40a. Unlike the high content of filling material-containing region R1, the end of the high content of filling material-containing region R2 in direction Y does not reach the outer peripheral side of the solid electrolyte composite 40b. This can reduce the total amount of the filler and/or the porous substrate, can increase the energy density of the solid-state battery, and can maintain required strength.

The method of manufacturing the solid electrolyte composite 40b is not particularly limited, but may be a method in which the high content of filling material-containing region R2 is first formed by a mold corresponding to the shape of the high content of filling material-containing region R2 using a solid electrolyte slurry in which a relatively large amount of the filler and/or the porous substrate is blended, and then the high content of filling material-containing region R2 formed above is immersed in a tank filled with a solid electrolyte slurry in which a relatively small amount of the filler and/or the porous substrate is blended, and dried.

### Fourth Embodiment

As shown in FIG. 7, a solid electrolyte composite 40c according to the present embodiment includes a positive electrode side solid electrolyte layer 41c and a negative electrode side solid electrolyte layer 42c. The solid electrolyte composite 40c has a high content of filling material-containing region R3. The high content of filling material-containing region R3 is a rib-shaped region obtained by further downscaling the high content of filling material-containing region R2 having a stepped shape. This can further reduce the total amount of the filler and/or the porous substrate compared to the solid electrolyte composite 40b, can improve the energy density of the solid-state battery, and can maintain necessary strength.

As a method for manufacturing the solid electrolyte composite 40c, a method similar to the method for manufacturing the solid electrolyte composite 40b can be adopted.

Although the embodiments of the present invention have been described above, the present invention is not limited to the above-described embodiments, and the above-described embodiments may be appropriately modified within the scope of the present invention. For example, the arrangement of the positive electrode layer and the negative electrode layer in the solid-state battery 1 may be reversed. In this case, the arrangement of the positive electrode side solid electrolyte layer and the negative electrode side solid electrolyte layer can also be reversed.

### EXPLANATION OF REFERENCE NUMERALS

1 Solid-state battery
21 Negative electrode material mixture layer (negative electrode layer)
22 Negative electrode current collector (negative electrode layer)
31 Positive electrode material mixture layer (positive electrode layer)
32 Positive electrode current collector (positive electrode layer)
40, 40a, 40b, and 40c Solid electrolyte composites
41 Positive electrode side solid electrolyte layer
42 Negative electrode side solid electrolyte layer
50 Intermediate layer
61 Insulating frame (insulating member)
62 Insulating layer (insulating member)
R1, R2, and R3 High content of filling material-containing regions

What is claimed is:

1. A solid electrolyte composite disposed between a positive electrode layer and a negative electrode layer in a solid-state battery,
comprising a positive electrode side solid electrolyte layer disposed in a side closer to the positive electrode layer and a negative electrode side solid electrolyte layer disposed in a side closer to the negative electrode layer,
the solid electrolyte composite having a stepped shape having a step between the positive electrode side solid electrolyte layer and the negative electrode side solid electrolyte layer,
at least the negative electrode side solid electrolyte layer comprising a filler and/or a porous substrate,
the negative electrode side solid electrolyte layer having a higher content of the filler and/or the porous substrate than the positive electrode side solid electrolyte layer.

2. The solid electrolyte composite according to claim 1, wherein the negative electrode side solid electrolyte layer has a lower content of the filler and/or the porous substrate in a vicinity of an interface in a side closer to the negative electrode layer and a vicinity of an interface in a side closer to the positive electrode side solid electrolyte layer than in another portion, and
the positive electrode side solid electrolyte layer has a lower content of the filler and/or the porous substrate in a vicinity of an interface in a side closer to the positive electrode layer and a vicinity of an interface in a side closer to the negative electrode side solid electrolyte layer than in another portion.

3. The solid electrolyte composite according to claim 2, wherein the solid-state battery further comprises an insulating member, and
each of the positive electrode side solid electrolyte layer and the negative electrode side solid electrolyte layer has a lower content of the filler and/or the porous substrate in a vicinity of an interface with the insulating member than in another portion.

4. The solid electrolyte composite according to claim 1, wherein a high content of filling material-containing region that comprises the filler and/or the porous substrate in a higher content than another portion is provided inside the solid electrolyte composite, and
the high content of filling material-containing region has a stepped shape having a step between the side closer to the positive electrode side solid electrolyte layer and the side closer to the negative electrode side solid electrolyte layer.
